(19) United States
(12) Patent Application Publication
(10) Pub. No.: US 2017/0123107 A1
(43) Pub. Date: May 4, 2017

(54) HIGH-REFRACTIVE COMPOSITION, ANTI-REFLECTIVE FILM AND PRODUCTION METHOD THEREOF

(71) Applicant: LG Hausys, Ltd., Seoul (KR)

(72) Inventors: Hong-Kwan CHO, Anyang-si, Gyeonggi-do (KR); Heon-Jo KIM, Suwon-si, Gyeonggi-do (KR); Won-Kook KIM, Daejeon (KR); Joo-Hee HONG, Uiwang-si, Gyeonggi-do (KR); Yu-Jun KIM, Anyang-si, Gyeonggi-do (KR)

(21) Appl. No.: 15/317,974

(22) PCT Filed: May 29, 2015
(86) PCT No.: PCT/KR2015/005423

§ 371 Date: Dec. 12, 2016

(30) Foreign Application Priority Data
Jun. 13, 2014 (KR) 10-2014-0072367

(51) Int. Cl. G02B 1/111; C08G 77/22

(52) U.S. Cl. CPC G02B 1/111; C08G 77/22

(57) ABSTRACT

Provided is a high-refractive composition comprising: an organic oligosiloxane of a network structure containing a metal, in which Si is partly substituted by a metal so as to contain a metal; and a photocurable acrylate-based compound, wherein the metal comprises at least one selected from a group consisting of titanium, zirconium and a combination thereof. Further provided are an anti-reflective film and a production method thereof, the anti-reflective film comprising a high-refractive layer which is formed by photocuring the high-refractive composition.

### TECHNICAL FIELD

The present invention relates to a high-refractive composition, an anti-reflective film, and a production method thereof.

### BACKGROUND ART

When a display is exposed to external light such as various illumination and natural light, an image formed inside the display is not clearly focused on an eye due to reflected light, thereby causing deterioration in contrast of the display. Due to such deterioration in contrast, a person has a difficulty in viewing a screen, and feels fatigue in the eye, or suffers from a headache. For these reasons, importance of anti-reflection has been gradually increased.

In the existing anti-reflective films, an anti-reflective layer is disposed on a transparent substrate, and the anti-reflective layer has a three layered structure in which a hard coating layer, a refractive index layer and a low refractive index layer are successively stacked on the transparent substrate.

Further, a high-refractive layer is generally formed by including high priced metal oxide fine particles in a binder resin such as styrene-based, epoxy-based, or the like. However, since the cost of metal oxide fine particles is high, a production cost is increased. A low-refractive layer is formed by including silica particles in a fluorine-series of acrylic resins, etc. However, there is a problem in that compatibility between the acrylic resin and the silica particles is not good.

### DISCLOSURE

### Technical Problem

It is an aspect of the present invention to provide a high-refractive composition capable of overally and uniformly implementing a high refractive index to have uniform anti-reflective performance and excellent economic efficiency.

It is another aspect of the present invention to provide an anti-reflective film capable of implementing uniform anti-reflective performance and excellent economic efficiency.

It is still another aspect of the present invention to provide a production method of the anti-reflective film.

### Technical Solution

In accordance with one aspect of the present invention, a high-refractive composition includes: a metal-containing organic oligosiloxane having a network structure in which Si is partly substituted with a metal to contain the metal; and a photocurable acrylate-based compound, wherein the metal includes at least one selected from the group consisting of titanium, zirconium and a combination thereof.

A content of the metal-containing organic oligosiloxane having a network structure may be about 10 parts by weight to about 1000 parts by weight on the basis of 100 parts by weight of the photocurable (meth)acrylate-based compound.

An atomic ratio of the metal to Si contained in the metal-containing organic oligosiloxane having a network structure may be about 1:0.03 to about 1:5.90.

The network structure of the metal-containing organic oligosiloxane may partly include an open structure by a substituent.

The substituent in the metal-containing organic oligosiloxane may include C4-C18 (meth)acrylate-based functional group.

The substituent in the metal-containing organic oligosiloxane may further include at least one selected from the group consisting of C1-C10 alkoxide group, C1-C18 alkyl group, C2-C10 alkenyl group, C6-C18 aryl group, C3-C8 acetonate group, a halide group, and a combination thereof.

The metal-containing organic oligosiloxane may be a reaction product of a first composition including a titanium compound represented by Chemical Formula 1 below, a zirconium compound represented by Chemical Formula 2 below, or mixtures thereof; and a silane compound represented by Chemical Formula 3 below:

R¹ₓTi(OR²)₄₋ₓ [Chemical Formula 1]

R³_{y}Zr(OR⁴)_{4-y} [Chemical Formula 2]

R⁵_{z}Si(OR⁶)_{4-z} [Chemical Formula 3]

in Chemical Formulas 1 to 3, R¹, R³, and R⁵ are each independently C1-C10 alkoxide group, C1-C18 alkyl group, C2-C10 alkenyl group, C4-C18 (meth)acrylate group, C6-C18 aryl group, C3-C8 acetonate group, or a halide group, R², R⁴, and R⁶ are each independently H or C1-C6 alkyl group, and x, y, and z are each independently 0, 1 or 2.

A total content which is the sum of each content of the titanium compound represented by Chemical Formula 1 and the zirconium compound represented by Chemical Formula 2 may be about 10 parts by weight to about 1000 parts by weight on the basis of 100 parts by weight of the silane compound represented by Chemical Formula 3.

The photocurable acrylate-based compound may include at least one selected from the group consisting of acrylate-based monomers, oligomers, resins, and a combination thereof.

In accordance with another aspect of the present invention, an anti-reflective film includes: a high-refractive layer formed by photocuring the high-refractive composition as described above.

The anti-reflective film may further include: a low-refractive layer formed by curing a low-refractive composition on the high-refractive layer, the low-refractive composition including a fluorine-containing organic oligosiloxane having a network structure as a binder; and hollow silica particles.

A content of the fluorine-containing organic oligosiloxane having a network structure as a binder may be about 10 parts by weight to about 120 parts by weight on the basis of 100 parts by weight of the hollow silica particles.

The fluorine-containing organic oligosiloxane may be attached by chemical bonds onto surfaces of the hollow silica particles.

The network structure of the fluorine-containing organic oligosiloxane may partly include an open structure by a substituent.

The substituent in the fluorine-containing organic oligosiloxane may include C3-C18 fluoroalkyl group, C4-C18 (meth)acrylate group, or both of these groups.

The fluorine-containing organic oligosiloxane may be a reaction product of a second composition including the silane compound represented by Chemical Formula 3, and a fluorine-containing silane compound represented by Chemical Formula 4 below:

R⁷_{w}Si(OR⁸)_{4-w} [Chemical Formula 4]

in Chemical Formula 4, R⁷ is C3-C18 fluoroalkyl group, R⁸ is H or C1-C10 alkyl group, and w is each independently 0, 1 or 2.

A content of the fluorine-containing silane compound represented by Chemical Formula 4 may be about 0.1 part by weight to about 20 parts by weight on the basis of 100 parts by weight of the silane compound represented by Chemical Formula 3.

The first composition, the second composition, or both compositions may further include at least one selected from acid catalysts, water, and organic solvents.

In accordance with another aspect of the present invention, a production method of an anti-reflective film includes: forming a metal-containing organic oligosiloxane having a network structure in which Si is partly substituted with a metal to contain the metal, wherein the metal includes at least one selected from the group consisting of titanium, zirconium and a combination thereof; and preparing a high-refractive composition by mixing and stirring the metal-containing organic oligosiloxane and a photocurable acrylate-based compound.

The metal-containing organic oligosiloxane having a network structure may be formed by stirring a first composition including a titanium compound represented by Chemical Formula 1 below, a zirconium compound represented by Chemical Formula 2 below, or mixtures thereof; and a silane compound represented by Chemical Formula 3 below:

R¹ₓTi(OR²)₄₋ₓ [Chemical Formula 1]

R³_{y}Zr(OR⁴)_{4-y} [Chemical Formula 2]

R⁵_{z}Si(OR⁶)_{4-z} [Chemical Formula 3]

in Chemical Formulas 1 to 3, R¹, R³, and R⁵ are each independently C1-C10 alkoxide group, C1-C18 alkyl group, C2-C10 alkenyl group, C4-C18 (meth)acrylate group, C6-C18 aryl group, C3-C8 acetonate group, or a halide group, R², R⁴, and R⁶ are each independently H or C1-C6 alkyl group, and x, y, and z are each independently 0, 1 or 2.

### Advantageous Effects

The high-refractive composition may overally and uniformly implement a high refractive index to have uniform anti-reflective performance and excellent economic efficiency, and the anti-reflective film including a high-refractive layer formed by photocuring the high-refractive composition may implement uniform anti-reflective performance and excellent economic efficiency.

### DESCRIPTION OF DRAWINGS

FIG. 1 is a cross-sectional view schematically illustrating an anti-reflective film according to another exemplary embodiment of the present invention.

FIG. 2 is a process flow chart schematically illustrating a production method of an anti-reflective film according to still another exemplary embodiment of the present invention.

### BEST MODE

Hereinafter, exemplary embodiments of the present invention will be described in detail with reference to the accompanying drawings so that those skilled in the art may easily practice the present invention. The present invention may be implemented in various different ways and is not limited to the exemplary embodiments provided in the present description.

The description of parts deviating from the subject matter of the present invention will be omitted in order to clearly describe the present invention. Like reference numerals designate like elements throughout the specification.

In the drawings, the thickness of layers, films, panels, regions, etc., are exaggerated for clarity. In the drawings, the thickness of layers, films, panels, regions, etc., are exaggerated for clarity.

Hereinafter, formation of any configuration in “an upper part (or a lower part) or “on (or below)” of a substrate means that any configuration is formed while contacting an upper surface (or a lower surface) of the substrate, and is not limited to exclude other constitution between the substrate and any configuration formed on (or below) the substrate.

In an exemplary embodiment of the present invention, there is provided a high-refractive composition including: a metal-containing organic oligosiloxane having a network structure in which Si is partly substituted with a metal to contain the metal; and a photocurable acrylate-based compound, wherein the metal includes at least one selected from the group consisting of titanium, zirconium and a combination thereof.

In general, the high-refractive composition is prepared, for example, by mixing high-refractive metal oxide particles having a high refractive index with a binder resin such as styrene-based, epoxy-based, or the like. However, there are problems in that it is difficult to uniformly disperse the metal oxide particles, such that a uniform refractive index is not implemented, and the cost thereof is significantly high, such that the production cost is remarkably increased.

Further, when thermosetting resin such as the styrene-based resin, the epoxy-based resin, or the like, is used as the binder resin, there are problems in that a curing speed is slow, and even after thermal treatment is stopped and an aging process is performed, a thermal curing reaction is continuously performed in a product for a predetermined period, such that changes over time in which the refractive index is changed may occur. Accordingly, there is a difficulty in forming the desired refractive index, and a close attention is required on working conditions such as drying condition, aging condition, etc.

Accordingly, the high-refractive composition according to an exemplary embodiment of the present invention may include the metal-containing organic oligosiloxane having a network structure in which Si is partly substituted with a metal to contain the metal to thereby overally and more uniformly implement a high refractive index even without including high-priced metal oxide particles, thereby having advantages in that uniform anti-reflective performance and excellent economic efficiency are provided.

In addition, the photocurable (meth)acrylate-based compound may be included to perform curing at a rapid speed, such that a production time may be reduced to more improve processability and productivity. Further, after light irradiation is stopped and the aging process is performed, a photocuring reaction is not performed any longer, such that a desired refractive index may be more easily formed, and uniform physical properties for a long period of time may be implemented.

A content of the metal-containing organic oligosiloxane having a network structure may be about 10 parts by weight to about 1000 parts by weight, and specifically, about 100 parts by weight to about 1000 parts by weight, on the basis of 100 parts by weight of the photocurable (meth)acrylate-based compound. Within the above-described range of content, a high refractive index may be overally and uniformly implemented even without including the high-priced metal oxide particles, thereby economically implementing excellent anti-reflective performance, together with a low-refractive layer to be described below.

Si in organic oligosiloxane is partly substituted with the metal, such that the metal-containing organic oligosiloxane having a network structure contains the metal, wherein a degree at which the Si is substituted with the metal may be appropriately controlled depending on inventive purposes and natures, thereby implementing a desired level of high refractive index.

For example, an atomic ratio of the metal to Si contained in the metal-containing organic oligosiloxane having a network structure may be, for example, about 1:0.03 to about 1:5.90, and specifically, about 1:0.3 to about 1:5.90. By including the metal within the above-described range of atomic ratio, the high refractive index may be overally and uniformly implemented and the cost may not be excessively increased, such that excellent economic efficiency may be implemented.

Specifically, when the atomic ratio of the metal to Si is more than 1:5.90, surface hardness of the high-refractive layer formed by photocuring the high-refractive composition is low, and accordingly, when the low-refractive layer is formed on the high-refractive layer, physical damages such as crack, scratch, etc., may easily occur, and thus, haze of the anti-reflective film including the layers may be increased, which may deteriorate optical physical properties.

The network structure of the metal-containing organic oligosiloxane may partly include an open structure by a substituent. Specifically, the metal-containing organic oligosiloxane may include the substituent that breaks a bond of the network structure, and accordingly, may include the open structure in which the bond of the network structure is partly broken by the substituent.

The substituent in the metal-containing organic oligosiloxane may include C4-C18 (meth)acrylate-based functional group. The (meth)acrylate-based functional group having the above-described range of carbon atoms may be included to have an appropriate length of carbon chain, such that the photocuring reaction by light irradiation may be appropriately performed, and a hydrolysis reaction, a condensation reaction, a dehydration condensation reaction, a hydrolysis-polycondensation reaction, etc., to be described below may be easily performed.

In addition, the substituent may further include at least one selected from the group consisting of C1-C10 alkoxide group, C1-C18 alkyl group, C2-C10 alkenyl group, C6-C18 aryl group, C3-C8 acetonate group, a halide group, and a combination thereof. The halide group may be F, C1, Br, or I.

The metal-containing organic oligosiloxane is a reaction product of a first composition including a titanium compound represented by Chemical Formula 1 below, a zirconium compound represented by Chemical Formula 2 below, or mixtures thereof; and a silane compound represented by Chemical Formula 3 below:

R¹ₓTi(OR²)₄₋ₓ [Chemical Formula 1]

R³_{y}Zr(OR⁴)_{4-y} [Chemical Formula 2]

R⁵_{z}Si(OR⁶)_{4-z} [Chemical Formula 3]

in Chemical Formulas 1 to 3, R¹, R³, and R⁵ are each independently C1-C10 alkoxide group, C1-C18 alkyl group, C2-C10 alkenyl group, C4-C18 (meth)acrylate group, C6-C18 aryl group, C3-C8 acetonate group, or a halide group, R², R⁴, and R⁶ are each independently H or C1-C6 alkyl group, and x, y, and z are each independently 0, 1 or 2.

The titanium compound may include, for example, at least one selected from the group consisting of tetraethoxy titanium, tetramethoxy titanium, tetraisopropoxy titanium, tetrabutoxy titanium, tetra tert-butoxy titanium, titanium 2-ethyl hexyloxide, titanium oxyacetylacetonate, titanium diisopropoxybisacetyl acetonate, tetrachloro titanium, chloro triethoxy titanium, chloro trimethoxy titanium, chloro triisopropoxy titanium, dichlorodimethoxy titanium, dichlorodiethoxy titanium, dichlorodiisopropoxy titanium, dichlorodibutoxy titanium, diethoxydiisopropoxy titanium and a combination thereof. In addition, for example, the first composition may further include trialkylalkoxytitaniums such as trichloromethoxy titanium, trichloroethoxy titanium, etc., titanium bromide, titanium fluoride, titanium iodide, etc., as the titanium compound.

In addition, titanium compounds in which at least one of the alkoxide groups such as methoxy, ethoxy, etc., and the halide groups in the exemplified titanium compounds is substituted with a (meth)acrylate-based functional group, may be included. Accordingly, the substituent in the metal-containing organic oligosiloxane which is the reaction product of the first composition may include the (meth)acrylate-based functional group to perform photocuring, such that a production time may be reduced to improve processability and productivity.

Further, titanium compounds in which at least one of the alkoxide groups such as methoxy, ethoxy, etc., and the halide groups in the exemplified titanium compounds is substituted with an alkyl group, an alkenyl group, an aryl group, or an other halide group, may be included.

The zirconium compound may include, for example, at least one selected from the group consisting of tetramethoxy zirconium, tetraethoxy zirconium, tetrapropoxy zirconium, tetrabutoxy zirconium, tetra-tert-butoxy zirconium, tetraisopropoxy zirconium, tetraacetylacetonate zirconium, and a combination thereof. In addition, for example, the first composition may further include trialkylalkoxy zirconium, zirconium chloride, zirconium bromide, zirconium fluoride, zirconium iodide, zirconium acrylate, zirconium carboxyethyl acrylate, etc., as the zirconium compound.

In addition, zirconium compounds in which at least one of the alkoxide groups such as methoxy, ethoxy, etc., and the halide groups of the exemplified zirconium compounds is substituted with a (meth)acrylate-based functional group, may be included. Accordingly, the substituent in the metal-containing organic oligosiloxane which is the reaction product of the first composition may include the (meth)acrylate-based functional group to perform photocuring, such that a production time may be reduced to improve processability and productivity.

Further, zirconium compounds in which at least one of the alkoxide groups such as methoxy, ethoxy, etc., and the halide groups in the exemplified zirconium compounds is substituted with an alkyl group, an alkenyl group, an aryl group, or an other halide group, may be included.

The silane compound may include, for example, at least one selected from the group consisting of tetramethoxysilane, tetraethoxysilane, tetrapropoxysilane, tetraisopropoxysilane, tetra-n-butoxysilane, tetra-sec-butoxysilane, tetra-tert-butoxysilane, trimethoxysilane, triethoxysilane, methyltrimethoxysilane, methyltriethoxysilane, ethyltrimethoxysilane, ethyltriethoxysilane, n-propyltrimethoxysilane, n-propyltriethoxysilane, isobutyltriethoxysilane, cyclohexyltrimethoxysilane, phenyltrimethoxysilane, phenyltriethoxysilane, vinyltrimethoxysilane, vinyltriethoxysilane, allyltrimethoxysilane, allyltriethoxysilane, dimethyldimethoxysilane, dimethyldiethoxysilane, diphenyldimethoxysilane, diphenyldiethoxysilane, trichloromethylsilane, trichlorochloromethylsilane, trichloro dichloromethyl silane, tetrachloro silane, dimethoxydimethyl silane, triacetoxy vinylsilane, trichlorooctadecyl silane, trichlorooctyl silane, acryloxypropyl trimethoxy silane, acryloxypropyl triethoxy silane, methacryloxypropyl trimethoxy silane, methacryloxypropyl triethoxy silane, methacryloxymethyl trimethoxy silane, methacryloxymethyl triethoxy silane, methacryloxymethyl methyl dimethoxy silane, methacryloxymethyl methyl diethoxy silane, methacryloxypropyl methyl dimethoxy silane, methacryloxypropyl methyl diethoxy silane, methacryloxypropyl dimethyl methoxy silane, methacryloxypropyl dimethyl ethoxy silane, and a combination thereof. In addition, for example, the first composition may further include trialkylalkoxysilane, etc., as the silane compound.

In addition, silane compounds in which at least one of the alkoxide groups such as methoxy, ethoxy, etc., and the halide groups in the exemplified silane compounds is substituted with a (meth)acrylate-based functional group, may be included. Accordingly, the substituent in the metal-containing organic oligosiloxane which is the reaction product of the first composition may include the (meth)acrylate-based functional group to perform photocuring, such that a production time may be reduced to improve processability and productivity.

Further, silane compounds in which at least one of the alkoxide groups such as methoxy, ethoxy, etc., and the halide groups in the exemplified silane compounds is substituted with an alkyl group, an alkenyl group, an aryl group, or an other halide group, may be included.

As described above, the silane compound represented by Chemical Formula 3 may be included and reacted as a unimolecular compound rather than polymers such as polysiloxane, etc., such that titanium or zirconium may be more uniformly and stably dispersed in the high-refractive composition to implement a uniform refractive index.

For example, the first composition may be subjected to a sol-gel reaction to form the metal-containing organic oligosiloxane. The reaction product of the first composition may specifically include reaction products of a hydrolysis reaction, a condensation reaction, or both of these reactions. For example, during the sol-gel reaction, the hydrolysis reaction of silane alkoxide, etc., may be generated at first, and then the condensation reaction may be generated between the silane compounds having hydroxy groups formed by the hydrolysis reaction. However, the present invention is not limited to these reactions, but the hydrolysis reaction, the condensation reaction, etc., may be performed according to various reaction routes.

A total content which is the sum of each content of the titanium compound represented by Chemical Formula 1 and the zirconium compound represented by Chemical Formula 2 may be about 10 parts by weight to about 1000 parts by weight, and specifically, about 100 parts by weight to about 1000 parts by weight, on the basis of 100 parts by weight of the silane compound represented by Chemical Formula 3.

When the above-described range of contents, the refractive index of the high-refractive composition may be implemented to be high, and at the same time, the reaction speed may be appropriately controlled to inhibit a gelation reaction, thereby improving storage stability. In addition, an atomic ratio of the metal to Si contained in the metal-containing organic oligosiloxane having a network structure may be, for example, about 1:0.03 to about 1:5.90, such that excellent optical physical properties may be implemented while improving the refractive index.

The high-refractive composition may include the photocurable (meth)acrylate-based compound as described above, such that the high-refractive composition may be cured at a rapid speed, and thus, excellent processability and productivity may be implemented.

The photocurable (meth)acrylate-based compound may include at least one selected from the group consisting of (meth)acrylate-based monomers, oligomers, resins, and a combination thereof.

In addition, the photocurable (meth)acrylate-based compound may include, for example, a polyfunctional (meth)acrylate-based monomer to improve crosslinking property, and specifically, the polyfunctional (meth)acrylate-based monomer may include, for example, a trifunctional or higher (meth)acrylate-based monomer to effectively improve crosslinking property. Accordingly, the high-refractive layer formed by curing the high-refractive composition may increase crossliking density and hardness to implement excellent durability.

The (meth)acrylate-based monomer may include, for example, at least one selected from the group consisting of methyl (meth)acrylate, ethyl (meth)acrylate, n-propyl (meth)acrylate, isopropyl (meth)acrylate, n-butyl (meth)acrylate, t-butyl (meth)acrylate, sec-butyl (meth)acrylate, pentyl (meth)acrylate, 2-ethylhexyl (meth)acrylate, 2-ethylbutyl (meth)acrylate, n-octyl (meth)acrylate, isooctyl (meth)acrylate, isononyl (meth)acrylate, lauryl (meth)acrylate, tetradecyl (meth)acrylate, and hydroxyethyl (meth)acrylate, and a combination thereof.

The (meth)acrylate-based oligomer may include (meth)acrylate-based oligomers having various kinds of functional groups such as alkyl (meth)acrylate, alkylene glycol (meth)acrylate, carboxyl group and unsaturated double bond-containing (meth)acrylate, hydroxyl group-containing (meth)acrylate, nitrogen-containing (meth)acrylate, etc., but the present invention is not limited thereto.

The (meth)acrylate-based resin may include at least one selected from the group consisting of dipentaerythritol hexaacrylate, dipentaerythritol pentaacrylate, pentaerythritol triacrylate, tetramethylolmethane tetraacrylate, tetramethylolmethane triacrylate, trimethanolpropane triacrylate, 1,6-hexanediol diacrylate, polyethylene glycol diacrylate, diethylene glycol acrylate, triethylene glycol acrylate, tetraethylene glycol acrylate, hexamethylene glycol acrylate, propyl acrylate, butyl acrylate, pentyl acrylate, 2-ethylhexyl acrylate, octyl acrylate, nonyl acrylate, bisphenol A diglycidyl diacrylate, bisphenol A epoxy acrylate, ethyleneoxide addition bisphenol A diacrylate, 2-phenoxyethyl acrylate, and a combination thereof, but the present invention is not limited thereto.

The polyfunctional (meth)acrylate-based monomer may be, for example, a bifunctional (meth)acrylate-based monomer or a twelve-functional (meth)acrylate-based monomer, and specifically, bifunctional acrylates such as 1,2-ethyleneglycol diacrylate, 1,12-dodetane diol acrylate, 1,4-butanediol di(meth)acrylate, 1,6-hexanediol di(meth)acrylate, neopentylglycol di(meth)acrylate, polyethylene glycol di(meth)acrylate, neopentylglycol adipate di(meth)acrylate, hydroxyl puivalic acid neopentylglycol di(meth)acrylate, dicyclopentanyl di(meth)acrylate, caprolactone-modified dicyclopentenyl di(meth)acrylate, ethyleneoxide-modified di(meth)acrylate, di(meth)acryloxy ethyl isocyanurate, allyl cyclohexyl di(meth)acrylate, tricyclodecanedimethanol(meth)acrylate, dimethylol dicyclopentane di(meth)acrylate, ethyleneoxide-modified hexahydrophthalic acid di(meth)acrylate, tricyclodecane dimethanol(meth)acrylate, neopentylglycol-modified trimethylpropane di(meth)acrylate, adamantane di(meth)acrylate or 9,9-bis[4-(2-acryloyloxyethoxy)phenyl]fluorine, etc.; trifunctional acrylates such as trimethylolpropane tri(meth)acrylate, dipentaerythritol tri(meth)acrylate, propionic acid-modified dipentaerythritol tri(meth)acrylate, pentaerythritol tri(meth)acrylate, propylene oxide-modified trimethylolpropane tri(meth)acrylate, trifunctional urethane (meth)acrylate or tris(meth)acryloxyethylisocyanurate, etc.; tetrafunctional acrylates such as diglycerine tetra(meth)acrylate or pentaerythritol tetra(meth)acrylate, etc.; pentafunctional acrylates such as propionic acid-modified dipentaerythritol penta(meth)acrylate, etc.; and hexafunctional acrylates such as dipentaerythritol hexa(meth)acrylate, caprolactone-modified dipentaerythritol hexa(meth)acrylate or urethane (meth)acrylate (ex. reaction materials of isocyanate monomer and trimethylolpropane tri(meta)acrylate), etc., but the present invention is not limited thereto.

The first composition may further include at least one selected from acid catalysts, water, and organic solvents.

The acid catalyst may be, for example, an inorganic acid or an organic acid, and specifically, nitric acid, hydrochloric acid, sulfuric acid, acetic acid, etc.

The organic solvent may include, for example, alcohols such as methanol, isopropyl alcohol (IPA), ethylene glycol, butanol, etc.; ketones such as methyl ethyl ketone, methyl isobutyl ketone (MIBK), etc.; esters such as ethyl acetate, butyl acetate, γ-butyrolactone, etc.; ethers such as tetrahydrofuran, 1,4-dioxane, etc.; and a combination thereof.

In an exemplary embodiment, the high-refractive composition may further include a photoinitiator, for example, at least one selected from the group consisting of 1-hydroxy-cyclohexyl-phenol-ketone, 2-methyl-1[4-(methylthio)phenyl]-2-morpholinopropane-1-one, benzyldimethylketone, 1-(4-dodecylphenyl)-2-hydroxy-2-methylpropane-1-one, 2-hydroxy-2-methyl-1-phenylpropane-1-one, 1-(4-isopropylphenyl)-2-hydroxy-2-methylpropane-1-one, benzophenone, 2,2-dimethoxy-2-phenylacetophenone, 2,2-diethoxy-2-phenylacetophenone, 2-hydroxy-2-methyl-1-propan-1-one, 4,4′-diethylaminobenzophenone, dichlorobenzophenone, 2-methylanthraquinone, 2-ethylanthraquinone, 2-methylthioxanthone, 2-ethyloxanthone, 2,4-dimethylthioxanthone, 2,4-diethyloxanthone, and a combination thereof, but the present invention is not limited thereto.

In accordance with another aspect of the present invention, there is provided an anti-reflective film including: a high-refractive layer formed by photocuring the high-refractive composition as described above. The high-refractive composition is the same as described above in one exemplary embodiment of the present invention.

The anti-reflective film may include the high-refractive layer formed by photocuring the high-refractive composition including the metal-containing organic oligosiloxane, thereby overally and more uniformly implementing a high refractive index even without including the high-priced metal oxide particles, such that there are advantages in that uniform anti-reflective performance and excellent economic efficiency are provided.

The high-refractive layer may be formed, for example, by hot-air drying the high-refractive composition, followed by photocuring and aging process.

The photocuring may be, for example, UV curing, etc., and may be performed by using a general metal halide lamp, etc., but the present invention is not limited thereto.

The hydrolysis reaction, the condensation reaction, etc., may be further performed while simultaneously evaporating a solvent by the hot-air drying. For example, the hot-air drying may be performed at a temperature of about 50° C. to about 200° C. for about 1 minute to about 10 minutes, but the present invention is not limited thereto.

In addition, the aging process may be applied to further perform the hydrolysis reaction, the condensation reaction, etc., between non-reacted compounds remaining in the high-refractive composition. The aging process may be performed at a temperature of about 40° C. to about 80° C. for about 10 hours to about 100 hours, but the present invention is not limited thereto.

A refractive index of the high-refractive layer may be, for example, about 1.4 to about 1.73, and specifically, about 1.51 to about 1.73. Within the above-described range of high level of refractive index, a destructive interference phenomenon of lights reflected on interfaces of each layer, etc., may be improved together with the low-refractive layer to be described below, such that excellent anti-reflective performance may be implemented in a wider wavelength region.

A thickness of the high-refractive layer may be, for example, about 50 nm to about 200 nm. Within the above-described range of thickness, excellent anti-reflective performance may be implemented together with the low-refractive layer to be described below, without forming an excessively thick thickness of the anti-reflective film and without increasing the cost.

In another exemplary embodiment, the anti-reflective film may further include the low-refractive layer on the high-refractive layer.

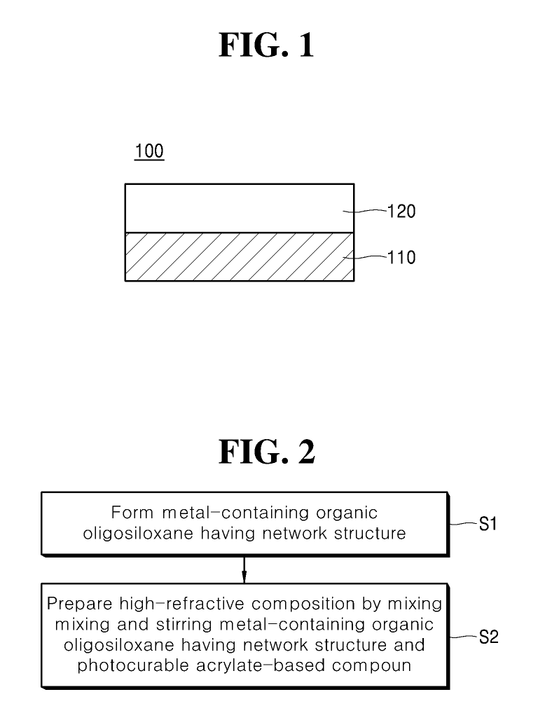

For example, the anti-reflective film may further include the low-refractive layer formed by curing a low-refractive composition including a fluorine-containing organic oligosiloxane having a network structure; and hollow silica particles. FIG. 1 is a cross-sectional view schematically illustrating the anti-reflective film 100 including the high-refractive layer 110 and the low-refractive layer 120 formed on the high-refractive layer 110.

The fluorine-containing organic oligosiloxane may be attached by chemical bonds on surfaces of the hollow silica particles, wherein the chemical bond may be, for example, a siloxane bond, i.e., Si—O—Si bond.

As described above, the low-refractive composition may include the fluorine-containing organic oligosiloxane having a network structure as a binder; and the hollow silica particles having the surfaces onto which the fluorine-containing organic oligosiloxane having a network structure is attached by the chemical bonds.

The network structure of the fluorine-containing organic oligosiloxane may partly include an open structure by a substituent. Specifically, the fluorine-containing organic oligosiloxane may include the substituent that breaks a bond of the network structure, and accordingly, may include the open structure in which the bond of the network structure is partly broken by the substituent.

The low-refractive composition may include the fluorine-containing organic oligosiloxane having a network structure as a binder, for example, in a content of about 10 parts by weight to about 120 parts by weight on the basis of 100 parts by weight of the hollow silica particles, and further, for example, about 20 parts by weight to about 100 parts by weight. Within the above-described range of content, the low-refractive layer formed by curing the low-refractive composition may have a much lower refractive index without causing an efflorescence phenomenon, and accordingly, excellent anti-reflective performance may be implemented together with the above-described high-refractive layer.

The substituent in the fluorine-containing organic oligosiloxane may include C3-C18 fluoroalkyl group, C4-C18 (meth)acrylate group, or both of these groups.

As described above, in the fluorine-containing organic oligosiloxane, a fluoroalkyl group substituted with at least one fluorine may be present to implement a low refractive index, and a (meth)acrylate group may be present to perform a photocuring reaction.

Further, since at least one photocurable (meth)acrylate-based functional group may be present in the fluorine-containing organic oligosiloxane to perform the photocuring reaction, the curing may be performed at a rapid speed to reduce a production time, such that processability and productivity may be more improved.

The fluorine-containing organic oligosiloxane is a reaction product of a second composition including the silane compound represented by Chemical Formula 3, and a fluorine-containing silane compound represented by Chemical Formula 4 below:

R⁷_{w}Si(OR)_{4-w} [Chemical Formula 4]

in Chemical Formula 4, R⁷ is C3-C18 fluoroalkyl group, R⁸ is H or C1-C10 alkyl group, and w is each independently 0, 1 or 2.

The silane compound represented by Chemical Formula 3 is the same as described above in an exemplary embodiment of the present invention.

The fluorine-containing silane compound represented by Chemical Formula 4 may include, for example, at least one selected from the group consisting of trifluoromethyl trimethoxysilane, trifluoromethyl triethoxysilane, trifluoropropyl trimethoxysilane, trifluoropropyl triethoxysilane, nonafluorobutyl ethyltrimethoxysilane, nonafluorobutyl ethyltriethoxysilane, nonafluorohexyl trimethoxysilane, nonafluorohexyl triethoxysilane, tridecafluorooctyl trimethoxysilane, tridecafluorooctyl triethoxysilane, heptadecafluorodecyl trimethoxysilane, heptadecafluorodecyl triethoxysilane, and a combination thereof. In addition, for example, the second composition may further include trialkylalkoxysilane, etc., as the silane compound.

A content of the fluorine-containing silane compound represented by Chemical Formula 4 may be, for example, about 0.1 part by weight to about 20 parts by weight, and specifically, about 5 parts by weight to about 10 parts by weight, on the basis of 100 parts by weight of the silane compound represented by Chemical Formula 3. Within the above-described range of content, surface energy may be appropriately reduced while appropriately increasing water contact angel of the low-refractive layer formed by curing the low-refractive composition, and accordingly, a low refractive index and excellent pollution resistance may be implemented, and excellent attachment force may be provided, thereby being applicable to a touch panel, etc.

The first composition, the second composition, or both compositions may further include at least one selected from acid catalysts, water, and organic solvents. The acid catalyst and the organic solvent are the same as described above in one exemplary embodiment of the present invention.

The hollow silica particle may be, for example, silica particle formed from a silica compound or an organic silicon compound, and may have an empty space present on a surface or an inside of the silica particle, or both of the surface and the inside of the silica particle.

For example, the hollow silica particles have a form in which they are dispersed in a dispersion medium such as water, organic solvent, or the like, wherein the hollow silica particles may be included in a colloidal phase in which a solid content of the hollow silica particles is 5 to 40 wt %. The organic solvent that is usable as a dispersion medium may be alcohols such as methanol, isopropyl alcohol (IPA), ethylene glycol, butanol, etc.; ketones such as methyl ethyl ketone, methyl isobutyl ketone (MIBK), etc.; aromatic hydrocarbons such as toluene, xylene, etc.; amides such as dimethyl formamide, dimethyl acetamide, N-methyl pyrrolidone, etc.; esters such as ethyl acetate, butyl acetate, γ-butyrolactone, etc.; ethers such as tetrahydrofuran, 1,4-dioxane, etc.; and mixtures thereof.

A number average diameter of the hollow silica particle may be, for example, about 1 nm to about 1,000 nm, and further, for example, about 5 nm to about 500 nm. Within the above-described range of number average diameter, the anti-reflective film may simultaneously implement excellent transparency and anti-reflective performance.

The low-refractive composition may further include a photoinitiator, and the low-refractive composition may be photocured to form a low-refractive layer. For example, the low-refractive composition may be subjected to hot-air drying and photocuring, and then, aging process, thereby forming a low-refractive layer. The photoinitiator, the hot-air drying, and the aging process are the same as described above in one exemplary embodiment of the present invention.

For example, the low-refractive layer may have a thickness of about 50 nm to about 200 nm. Within the above-described range of thickness, a relative thickness ratio with the high-refractive layer as described above may be appropriately controlled without forming an excessively thick thickness of the anti-reflective film and without increasing the cost, thereby more improving a destructive interference phenomenon of light, etc., such that excellent anti-reflective performance may be implemented.

A thickness ratio of the high-refractive layer to the low-refractive layer may be about 1:1 to about 1:4. Within the above-described range of thickness ratio, the anti-reflective film may more improve the destructive interference phenomenon of light, etc., to implement excellent anti-reflective performance.

A water contact angle of the low-refractive layer may be, for example, about 40° to about 80°. Within the above-described range of water contact angle, surface energy may be appropriately reduced to harmonize pollution resistance and adhesion force, thereby simultaneously implementing both of the pollution resistance and the attachment force to excellent level.

The low-refractive layer may have a refractive index of about 1.20 to about 1.25. Within the low level of refractive index in the above-described range, excellent anti-reflective performance may be implemented together with the above-described high-refractive layer.

The anti-reflective film may have a light transmittance of about 94% to about 98% and a luminous reflectance of about 0.2 to about 1.0, the luminous reflectance measured at a temperature of about 23° C., such that excellent light transmittance and anti-reflective performance may be implemented.

FIG. 2 is a process flow chart schematically illustrating a production method of an anti-reflective film according to still another exemplary embodiment of the present invention.

In still another exemplary embodiment of the present invention, there is provided a production method of an anti-reflective film including: (S1) forming a metal-containing organic oligosiloxane having a network structure in which Si is partly substituted with a metal to contain the metal, wherein the metal includes at least one selected from the group consisting of titanium, zirconium and a combination thereof; and (S2) preparing a high-refractive composition by mixing and stirring the metal-containing organic oligosiloxane and a photocurable acrylate-based compound.

According to the production method, the metal-containing organic oligosiloxane having a network structure in which Si is partly substituted with a metal to contain the metal may be prepared to overally and more uniformly implement a high refractive index even without including the high-priced metal oxide particles, thereby having advantages in that uniform anti-reflective performance and excellent economic efficiency are simultaneously provided.

Further, a photocurable (meth)acrylate compound may be included to perform curing at a rapid speed, thereby reducing a production time, such that processability and productivity may be more improved.

The metal-containing organic oligosiloxane having a network structure may be formed by stirring a first composition including a titanium compound represented by Chemical Formula 1 below, a zirconium compound represented by Chemical Formula 2 below, or mixtures thereof; and a silane compound represented by Chemical Formula 3 below:

R¹ₓTi(OR²)₄₋ₓ [Chemical Formula 1]

R³_{y}Zr(OR⁴)_{4-y} [Chemical Formula 2]

R⁵_{z}Si(OR⁶)_{4-z} [Chemical Formula 3]

in Chemical Formulas 1 to 3, R¹, R³, and R⁵ are each independently C1-C10 alkoxide group, C1-C18 alkyl group, C2-C10 alkenyl group, C4-C18 (meth)acrylate group, C6-C18 aryl group, C3-C8 acetonate group, or a halide group, R², R⁴, and R⁶ are each independently H or C1-C6 alkyl group, and x, y, and z are each independently 0, 1 or 2.

In the production method, the titanium compound represented by Chemical Formula 1, the zirconium compound represented by Chemical Formula 2, the silane compound represented by Chemical Formula 3, and the first composition are the same as described above in one exemplary embodiment of the present invention.

The first composition may be prepared, for example, so that a total content which is the sum of each content of the titanium compound represented by Chemical Formula 1 and the zirconium compound represented by Chemical Formula 2 is about 10 parts by weight to about 1000 parts by weight, and specifically, about 100 parts by weight to about 1000 parts by weight, on the basis of 100 parts by weight of the silane compound represented by Chemical Formula 3.

When the first composition is mixed and prepared within the above-described range of content, the refractive index of the high-refractive composition may be implemented to be high, and at the same time, the reaction speed may be appropriately controlled to inhibit a gelation reaction, thereby improving storage stability. In addition, an atomic ratio of the metal to Si contained in the metal-containing organic oligosiloxane having a network structure may be, for example, about 1:0.03 to about 1:5.90, such that excellent optical physical properties may be implemented while improving the refractive index.

The first composition may further include at least one selected from the group consisting of acid catalysts, water, and organic solvents.

The first composition may be stirred, for example, at about 20° C. to about 60° C. for about 3 hours to about 40 hours, and accordingly, for example, the first composition may be subjected to a sol-gel reaction. Specifically, the first composition may be stirred under the above-described range of temperature and time conditions, such that a hydrolysis reaction, a condensation reaction, a dehydration condensation reaction, a hydrolysis-polycondensation reaction, etc., may be sufficiently performed, and accordingly, the metal-containing organic oligosiloxane having a network structure may be easily formed.

To the first composition including the metal-containing organic oligosiloxane having a network structure as described above, the photocurable acrylate-based compound may be mixed and stirred to prepare the high-refractive composition. The metal-containing organic oligosiloxane having a network structure is the same as described above in one exemplary embodiment of the present invention.

The photocurable (meth)acrylate-based compound may include at least one selected from the group consisting of (meth)acrylate-based monomers, oligomers, resins, and a combination thereof, and specifically, may include a polyfunctional (meth)acrylate-based monomer to improve crosslinking property.

In addition, the polyfunctional (meth)acrylate-based monomer may specifically include a trifunctional or higher (meth)acrylate-based monomer to more improve crosslinking property, thereby implementing excellent crossliking density and hardness. The photocurable acrylate-based compound is the same as described above in one exemplary embodiment of the present invention.

The production method may further include: preparing a low-refractive composition including a fluorine-containing organic oligosiloxane having a network structure; and hollow silica particles.

Further, the production method may further include: forming the fluorine-containing organic oligosiloxane having a network structure by reacting the silane compound represented by Chemical Formula 3, and a fluorine-containing silane compound represented by Chemical Formula 4 below:

R⁷_{w}Si(OR)_{4-w} [Chemical Formula 4]

in Chemical Formula 4, R⁷ is C3-C18 fluoroalkyl group, R⁸ is H or C1-C10 alkyl group, and w is each independently 0, 1 or 2.

The fluorine-containing silane compound represented by Chemical Formula 4 and the second composition are the same as described above in one exemplary embodiment of the present invention.

The first composition, the second composition, or both of these compositions may further include at least one selected from the group consisting of acid catalysts, water, and organic solvents. The acid catalyst and the organic solvent are the same as described above in one exemplary embodiment of the present invention.

The second composition may be stirred, for example, at about 20° C. to about 60° C. for about 4 hours to about 80 hours, and accordingly, for example, the second composition may be subjected to a sol-gel reaction. Specifically, the second composition may be stirred under the above-described range of temperature and time conditions, such that a hydrolysis reaction, a condensation reaction, a dehydration condensation reaction, a hydrolysis-polycondensation reaction, etc., may be sufficiently performed, and accordingly, the fluorine-containing organic oligosiloxane having a network structure may be easily formed. The fluorine-containing organic oligosiloxane having a network structure is the same as described above in one exemplary embodiment of the present invention.

As described above, the low-refractive composition may be prepared by mixing the hollow silica particles with the second composition including the formed fluorine-containing organic oligosiloxane having a network structure, followed by stirring at about 20° C. to about 40° C. for about 5 hours to about 50 hours. By stirring under the above-described range of temperature and time conditions, the fluorine-containing organic oligosiloxane may be appropriately attached by chemical bonds onto surfaces of the hollow silica particles, and accordingly, the hollow silica particles may have a low refractive index and a low surface energy. The chemical bond may be, for example, a siloxane bond, i.e., Si—O—Si bond.

Accordingly, the low-refractive composition may include the fluorine-containing organic oligosiloxane having a network structure as a binder; and the hollow silica particles having the surfaces onto which the fluorine-containing organic oligosiloxane having a network structure is attached by the chemical bonds.

The production method may further include: forming a high-refractive layer by applying the high-refractive composition on at least one surface of a substrate film, followed by photocuring.

The substrate may be various kinds of transparent substrates, transparent resin laminates, etc., known in the art without specific limitation, and for example, may be PET (polyethylene terephthalate), PEN (polyethylenenaphthalate), PES (polyethersulfone), PC (poly carbonate), PP (poly propylene), norbornene-based resin, etc., but the present invention is not limited thereto.

In addition, the production method may further include: forming a low-refractive layer by applying the low-refractive composition on the high-refractive layer, followed by photocuring. The high-refractive layer and the low-refractive layer are the same as described above in one exemplary embodiment of the present invention.

The applying of the high-refractive composition and the low-refractive composition may be, for example, performed by using a gravure coating method, a slot die coating method, a spin coating method, a spray coating method, a bar coating method, a deposition coating method, etc., but the present invention is not limited thereto.

The photocuring may be, for example, UV curing, etc., and may be performed by using a general metal halide lamp, etc., but the present invention is not limited thereto.

For example, the high-refractive composition may be subjected to hot-air drying and photocuring, thereby forming a high-refractive layer. Then, the low-refractive composition may be applied on the high-refractive layer, followed by hot-air drying and photocuring, thereby forming a low-refractive layer, followed by an aging process, thereby forming the anti-reflective film.

The hydrolysis reaction, the condensation reaction, etc., may be further performed while simultaneously evaporating a solvent by the hot-air drying. For example, the hot-air drying may be performed at a temperature of about 50° C. to about 200° C. for about 1 minute to about 10 minutes, but the present invention is not limited thereto.

The aging process may be applied to further perform the hydrolysis reaction, the condensation reaction, etc., between non-reacted compounds remaining in the high-refractive composition. The aging process may be performed at a temperature of about 40° C. to about 80° C. for about 10 hours to about 100 hours, but the present invention is not limited thereto.

The UV curing may be, for example, performed by irradiation with ultraviolet of about 100 mJ/cm² to about 1000 mJ/cm² to achieve sufficient photocuring, but the present invention is not limited thereto.

The anti-reflective film produced by the production method may have a light transmittance of about 94% to about 98% and a luminous reflectance of about 0.2 to about 1.0, the luminous reflectance measured at a temperature of about 23° C., such that excellent light transmittance and anti-reflective performance may be implemented.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

Hereinafter, Examples of the present invention are described. However, the following Examples are only provided as one exemplary embodiment of the present invention, and the present invention is not limited to the following Examples.

### EXAMPLES

### Example 1

100 parts by weight of tetraethoxy orthosilicate, 250 parts by weight of titanium tetraisopropoxide, 200 parts by weight of water, 200 parts by weight of ethanol, and 1 part by weight of IM nitric acid were mixed, and stirred at 25° C. for 48 hours, thereby preparing a first composition including a metal-containing organic oligosiloxane. Then, to the first composition, pentaerythritol triacrylate (PETA) and a photoinitiator (Igacure 184) were further mixed and stirred, thereby preparing a high-refractive composition. A content of the metal-containing organic oligosiloxane in the high-refractive composition was 400 parts by weight on the basis of 100 parts by weight of PETA.

In addition, 100 parts by weight of tetraethoxy orthosilicate, 10 parts by weight of 3,3,3-trifluoropropyl trimethoxysilane, 100 parts by weight of water, and 100 parts by weight of isopropyl alcohol were mixed, and stirred at 60° C. for 3 hours, thereby preparing a second composition including a fluorine-containing organic oligosiloxane, as a binder solution. Then, to the second composition, 60 parts by weight of hollow silica particle having a number average diameter of 60 nm-methyl isobutyl ketone dispersion sol (20% w/w, JGC C&C Corporation, Thrulya 4320) on the basis of 100 parts by weight of the second composition, and a photoinitiator (Igacure 184) were further mixed and stirred at room temperature for 24 hours, followed by dilution with methyl ethyl ketone, thereby preparing a low-refractive composition having a solid content of 3%.

Subsequently, the high-refractive composition was applied on one surface of a PET film having a thickness of 50 m, followed by hot-air drying at 120° C. for 2 minutes and irradiation with ultraviolet light of 300 mJ/cm², thereby forming a high-refractive layer having a thickness of 120 nm.

The low-refractive composition was applied on a surface of the high-refractive layer, followed by hot-air drying at 130° C. for 2 minutes and irradiation with ultraviolet light of 300 mJ/cm², thereby forming a low-refractive layer having a thickness of 90 nm.

In addition, subsequently, a laminate in which the PET film, the high-refractive layer, and the low-refractive layer were successively stacked was subjected to an aging process in an oven at 60° C. for 48 hours, thereby producing an anti-reflective film.

### Example 2

An anti-reflective film was produced by the same method and same conditions as Example 1 except for preparing the first composition by mixing 1000 parts by weight of titanium tetraisopropoxide.

### Comparative Example 1

An anti-reflective film was produced by the same method and same conditions as Example 1 except for preparing the high-refractive composition by mixing and stirring 100 parts by weight of pentaerythritol triacrylate (PETA), 100 parts by weight of polyfunctional urethane acrylate, 50 parts by weight of zirconium oxide particle dispersion sol, and a photoinitiator (Igacure 184).

### Comparative Example 2

A composition including 100 parts by weight of acrylic polyol (Desmophen A 265) and 60 parts by weight of IPDI (isophorondiisocyanate) was subjected to heat treatment to polymerize a polyurethane-based resin which is a thermosetting resin. Then, 50 parts by weight of zirconium oxide particle dispersion sol was added to 100 parts by weight of the composition including the polymerized polyurethane-based resin, followed by mixing and stirring, thereby preparing a high-refractive composition.

In addition, a low-refractive composition was prepared by the same method and same conditions as Example 1.

Subsequently, the high-refractive composition was applied on one surface of a PET film having a thickness of 50 m, followed by hot-air drying at 120° C. for 10 minutes, thereby forming a high-refractive layer having a thickness of 120 nm.

The low-refractive composition was applied on a surface of the high-refractive layer, followed by hot-air drying at 130° C. for 2 minutes and irradiation with ultraviolet light of 300 mJ/cm², thereby forming a low-refractive layer having a thickness of 90 nm.

In addition, subsequently, a laminate in which the PET film, the high-refractive layer, and the low-refractive layer were successively stacked was subjected to an aging process in an oven at 60° C. for 48 hours, thereby producing an anti-reflective film.

Evaluation

With regard to the anti-reflective films of Examples 1 and 2, and Comparative Examples 1 and 2, a refractive index of each of the low-refractive layers and the high-refractive layers was measured, and light transmittance, luminous reflectance, the lowest reflectance of each anti-reflective film was measured, and results thereof were shown in Table 1 below.

1. Refractive Index

Measurement method: Reflectance was measured at wavelengths of 532 nm, 632.8 nm, and 830 nm using a prism coupler, and Cauchy's dispersion formula as an approximate expression of refractive index wavelength dispersion was used to calculate optical constants of the Cauchy's dispersion formula by the method of least squares (curve fitting), thereby measuring each refractive index at a wavelength of 550 nm and a temperature of 23° C.

2. Light Transmittance

Measurement method: Light transmittance of each anti-reflective film having a thickness of about 50 μm was measured by using a hazemeter (Nippon Denshoku, NDH 5000).

3. Luminous Reflectance and Lowest Reflectance

Measurement method: A black tape for preventing back reflection of the anti-reflective film was attached onto an opposite surface to a surface on which the high-refractive layer of the PET substrate is formed, i.e., a lower surface, and luminous reflectance (D65) and the lowest reflectance of the surface of the low-refractive layer were evaluated at a temperature of 23° C. by using a spectrophotometer (Konica Minolta, CM-5).

As the luminous reflectance and the lowest reflectance were decreased, the anti-reflective film had excellent anti-reflective performance.

4. Whether Changes Over Time Occur

Measurement method: Each anti-reflective film of Examples 1 and 2, and Comparative Examples 1 and 2 was left in a high temperature chamber at 60° C. for 48 hours, and taken out.

Specifically, an initial luminous reflectance was measured at room temperature before each film was put into the high temperature chamber. Then, a final luminous reflectance was measured at room temperature right after each film was put into the high temperature chamber and left for 48 hours and taken out. The initial luminous reflectance and the final luminous reflectance were introduced into Calculation Formula 1 below to thereby calculate reflectance variation.

Reflectance variation (%)=final luminous reflectance (%)−initial luminous reflectance (%) [Calculation Formula 1]

When the reflectance variation was less than 0.2%, it was evaluated as a case where changes over time rarely occur, which is represented by “X”, and when the reflectance variation was more than 0.2%, it was evaluated as a case where changes over time occur, which is represented by “O”.

The initial luminous reflectance and the final luminous reflectance were measured by the same method as the measurement methods of the luminous reflectance and the lowest reflectance.

TABLE 1

| | | Light | Luminous | Lowest | |
|---|---|---|---|---|---|
| | | transmit- | reflec- | reflec- | Whether |
| | Refractive | tance | tance | tance | changes over |
| | index | (%) | (%) | (%) | time occur |
| Example 1 | Low- | 96 | 0.6 | 0.4 | X |
| | refractive | | | | |
| | layer: 1.28 | | | | |
| | High- | | | | |
| | refractive | | | | |
| | layer: 1.61 | | | | |
| Example 2 | Low- | 98 | 0.2 | 0.1 | X |
| | refractive | | | | |
| | layer: 1.28 | | | | |
| | High- | | | | |
| | refractive | | | | |
| | layer: 1.73 | | | | |
| Comparative | Low- | 94 | 1.2 | 0.9 | X |
| Example 1 | refractive | | | | |
| | layer: 1.28 | | | | |
| | High- | | | | |
| | refractive | | | | |
| | layer: 1.50 | | | | |
| Comparative | Low- | 95 | 0.8 | 0.7 | ◯ |
| Example 2 | refractive | | | | |
| | layer: 1.28 | | | | |
| | High- | | | | |
| | refractive | | | | |
| | layer: 1.64 | | | | |

It was confirmed that Examples 1 and 2 implemented a high level of refractive index of the high-refractive layer even at a low cost to thereby have excellent anti-reflective performance; meanwhile, even though Comparative Example 1 required high cost since it contained the metal oxide particles, the refractive index of the high-refractive layer was low, and the anti-reflective performance was poor, and it could be predicted that Comparative Example 1 had a much higher haze due to the particles.

Further, it could be clearly confirmed that Comparative Example 2 included the thermosetting resin to have occurrence of changes over time, and it could be predicted that a curing speed was relatively small, such that productivity was more reduced.

1. A high-refractive composition comprising:
a metal-containing organic oligosiloxane having a network structure in which Si is partly substituted with a metal to contain the metal; and
a photocurable (meth)acrylate-based compound,
wherein the metal includes at least one selected from the group consisting of titanium, zirconium and a combination thereof.

2. The high-refractive composition of claim 1, wherein a content of the metal-containing organic oligosiloxane having a network structure is about 10 parts by weight to about 1000 parts by weight on the basis of 100 parts by weight of the photocurable (meth)acrylate-based compound.

3. The high-refractive composition of claim 1, wherein an atomic ratio of the metal to Si contained in the metal-containing organic oligosiloxane having a network structure is 1:0.03 to 1:5.90.

4. The high-refractive composition of claim 1, wherein the network structure of the metal-containing organic oligosiloxane partly includes an open structure by a substituent.

5. The high-refractive composition of claim 4, wherein the substituent in the metal-containing organic oligosiloxane includes C4-C18 (meth)acrylate-based functional group.

6. The high-refractive composition of claim 5, wherein the substituent in the metal-containing organic oligosiloxane further includes at least one selected from the group consisting of C1-C10 alkoxide group, C1-C18 alkyl group, C2-C10 alkenyl group, C6-C18 aryl group, C3-C8 acetonate group, a halide group, and a combination thereof.

7. The high-refractive composition of claim 1, wherein the metal-containing organic oligosiloxane is a reaction product of a first composition including a titanium compound represented by Chemical Formula 1 below, a zirconium compound represented by Chemical Formula 2 below, or mixtures thereof; and a silane compound represented by Chemical Formula 3 below:
R¹ₓTi(OR²)₄₋ₓ [Chemical Formula 1]
R³_{y}Zr(OR⁴)_{4-y} [Chemical Formula 2]
R⁵_{z}Si(OR⁶)_{4-z} [Chemical Formula 3]
in Chemical Formulas 1 to 3, R¹, R³, and R⁵ are each independently C1-C10 alkoxide group, C1-C18 alkyl group, C2-C10 alkenyl group, C4-C18 (meth)acrylate group, C6-C18 aryl group, C3-C8 acetonate group, or a halide group, R², R⁴, and R⁶ are each independently H or C1-C6 alkyl group, and x, y, and z are each independently 0, 1 or 2.

8. The high-refractive composition of claim 7, wherein a total content which is the sum of each content of the titanium compound represented by Chemical Formula 1 and the zirconium compound represented by Chemical Formula 2 is 10 parts by weight to 1000 parts by weight on the basis of 100 parts by weight of the silane compound represented by Chemical Formula 3.

9. The high-refractive composition of claim 1, wherein the photocurable acrylate-based compound includes at least one selected from the group consisting of acrylate-based monomers, oligomers, resins, and a combination thereof.

10. An anti-reflective film comprising:
a high-refractive layer formed by photocuring the high-refractive composition of claim 1.

11. The anti-reflective film of claim 10, further comprising:
a low-refractive layer formed by curing a low-refractive composition on the high-refractive layer, the low-refractive composition including a fluorine-containing organic oligosiloxane having a network structure as a binder; and hollow silica particles.

12. The anti-reflective film of claim 11, wherein a content of the fluorine-containing organic oligosiloxane having a network structure as a binder is 10 parts by weight to 120 parts by weight on the basis of 100 parts by weight of the hollow silica particles.

13. The anti-reflective film of claim 11, wherein the fluorine-containing organic oligosiloxane is attached by chemical bonds onto surfaces of the hollow silica particles.

14. The anti-reflective film of claim 11, wherein the network structure of the fluorine-containing organic oligosiloxane partly includes an open structure by a substituent.

15. The anti-reflective film of claim 11, wherein the substituent in the fluorine-containing organic oligosiloxane includes C3-C18 fluoroalkyl group, C4-C18 (meth)acrylate group, or both of these groups.

16. The anti-reflective film of claim 11, wherein the fluorine-containing organic oligosiloxane is a reaction product of a second composition including the silane compound represented by Chemical Formula 3, and a fluorine-containing silane compound represented by Chemical Formula 4 below:
R⁷_{w}Si(OR⁸)_{4-w} [Chemical Formula 4]
in Chemical Formula 4, R⁷ is C3-C18 fluoroalkyl group, R⁸ is H or C1-C10 alkyl group, and w is each independently 0, 1 or 2.

17. The anti-reflective film of claim 16, wherein a content of the fluorine-containing silane compound represented by Chemical Formula 4 is 0.1 part by weight to 20 parts by weight on the basis of 100 parts by weight of the silane compound represented by Chemical Formula 3.

18. The anti-reflective film of claim 16, wherein the first composition, the second composition, or both of these compositions further include at least one selected from the group consisting of acid catalysts, water, and organic solvents.

19. A production method of an anti-reflective film comprising:
forming a metal-containing organic oligosiloxane having a network structure in which Si is partly substituted with a metal to contain the metal, wherein the metal includes at least one selected from the group consisting of titanium, zirconium and a combination thereof; and
preparing a high-refractive composition by mixing and stirring the metal-containing organic oligosiloxane and a photocurable (meth)acrylate-based compound.

20. The production method of claim 19, wherein the metal-containing organic oligosiloxane having a network structure is formed by stirring a first composition including a titanium compound represented by Chemical Formula 1 below, a zirconium compound represented by Chemical Formula 2 below, or mixtures thereof; and a silane compound represented by Chemical Formula 3 below:
R¹ₓTi(OR²)₄₋ₓ [Chemical Formula 1]
R³_{y}Zr(OR⁴)_{4-y} [Chemical Formula 2]
R⁵_{z}Si(OR⁶)_{4-z} [Chemical Formula 3]
in Chemical Formulas 1 to 3, R¹, R³, and R⁵ are each independently C1-C10 alkoxide group, C1-C18 alkyl group, C2-C10 alkenyl group, C4-C18 (meth)acrylate group, C6-C18 aryl group, C3-C8 acetonate group, or a halide group, R², R⁴, and R⁶ are each independently H or C1-C6 alkyl group, and x, y, and z are each independently 0, 1 or 2.
